(19) United States
(12) Patent Application Publication
(10) Pub. No.: US 2009/0030886 A1
(43) Pub. Date: Jan. 29, 2009

(54) Method of determining similar attributes between one or more users in a communications network

(76) Inventor: Hans Chandra Pandeya, Mosman (AU)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/220,691

(22) Filed: Jul. 25, 2008

(30) Foreign Application Priority Data
Jul. 26, 2007 (AU) 2007904024

(51) Int. Cl. G06F 17/30; G06F 15/16; G06F 7/06

(52) U.S. Cl. 707/3; 709/204; 709/206; 707/100; 707/E17.142

(57) ABSTRACT

A method of determining similar attributes between one or more users in a communications network (100) including the steps of: (a) determining (S305) one or more attributes of one or more users on a communications network; (b) comparing (S310) the one or more attributes of the one or more users on the communications network; (c) using (S315) an inference filter to determine the one or more attributes in common with the one or more users; and (d) representing (S320) the one or more users which have one or more attributes in common on a display.

### TECHNICAL FIELD

The present invention generally relates to methods and systems for determining similar attributes between users in a communications network. The communications network may include user terminals in the form of computers connected in a network such as the Internet or one or more user terminals in the form of a mobile communications device connected to a data communications network or the Internet.

### BACKGROUND ART

The Internet though the World Wide Web allows users to obtain a vast amount of information that is of interest to them. The use of the World Wide Web by more and more people also allows people to connect with each other people who share similar interests.

Many web sites are sites in which Internet users can find users who share the same interests. For example, a music related web site where the members the site interact with other similar minded users via a message board.

There also exist social networking sites and dating sites where a user can search for another user with certain interests. In this case, searching for a another user is done by entering key words, e.g. a search with the key words “Hemingway” would return a list of users that have included Ernest Hemingway as an author whose books they enjoy reading. The user can read the profiles of the users returned and contact them. A problem with this approach is that it is time consuming as many results may be returned.

Therefore, there exists a need for a method, system, computer readable medium of instructions, and/or a computer program product which can which addresses or at least ameliorate at least one of the problems inherent in the prior art.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### DISCLOSURE OF INVENTION

In a first broad form, the present invention provides a method of determining similar attributes between one or more users in a communications network including the steps of:
(a) determining one or more attributes of one or more users on a communications network;
(b) comparing the one or more attributes of the one or more users on the communications network;
(c) using an inference filter to determine the one or more attributes in common with the one or more users; and
(d) representing the one or more users which have one or more attributes in common on a display.

Preferably, the display is a coordinate system indicating the number of attributes in common between the one or more users.

Preferably, the display is a coordinate system having one or more axes, each axis representing an attribute.

Alternatively, the display is a coordinate system having one or more axes, each axis representing a combination of one or more attributes.

Preferably, a first user is represented at the origin of the coordinate system and one or more users having attributes in common with the first user are displayed on the coordinate system at a distance from the origin.

Preferably, the coordinate system is a Cartesian coordinate system.

Preferably, the distance from the first user at the origin is the number of attributes that the user has in common with one or more users.

Alternatively, the coordinate system is a polar coordinate system. A first user may be represented at the origin of the coordinate system and one or more users having attributes in common with the first user are displayed on the coordinate system at a distance and angle from the origin.

The attribute may be a URL, an ISBN or another unique identifier. The attribute may be selected from a predetermined list stored on a database. The predetermined list may be a list of musical artists, films or hobbies, or usage of software applications.

Preferably, the representation of the one or more users on the display indicates if the one or more users are on the communications network.

Preferably, the method further includes the step of initiating a chat program upon selecting a representation of the one or more users on the display.

Preferably, the method further includes the step of selecting a representation of the one or more users on the display and displaying one or more URLs which have been accessed by the one or more selected users.

Preferably, the method further includes the step of selecting the representation of the one or more users on the display and displaying one or more URL bookmarks associated with the one or more selected users.

In a second broad form, the present invention provides a method of determining similar attributes between one or more users in a communications network including the steps of:
(a) determining one or more URLs that a first user is currently visiting on the network;
(b) determining one or more other users currently visiting one or more URLs that match the one or more URLs in step (a) on the network;
(c) representing the one or more users currently visiting the one or more URLs that match the one or more URLs in step (a) on a display; and
(d) initiating a chat program upon a user selecting the representation of the one or more users on the display.

Preferably, the display is a list of users currently visiting one or more URLs that match the one or more URLs in step (a).

Preferably, the display indicates if the one or more users are available to chat.

Preferably, the method further includes the steps of
(e) determining one or more attributes of one or more users currently visiting one or more URLs in step (a);
(f) comparing the one or more attributes of the one or more users currently visiting one or more URLs in step (a);
(g) using an inference filter to determine the one or more attributes in common with the one or more users; and
(h) representing the one or more users which have one or more attributes in common on a display.

Preferably, the display is a coordinate system indicating the number of attributes in common between the one or more users.

Preferably, the display is a coordinate system having one or more axes, each axis representing an attribute.

Alternatively, the display is a coordinate system having one or more axes, each axis representing a combination of one or more attributes.

Preferably, a first user is represented at the origin of the coordinate system and one or more users having attributes in common with the first user are displayed on the coordinate system at a distance from the origin.

Preferably, the coordinate system is a Cartesian coordinate system.

Preferably, the distance from the first user at the origin is the number of attributes that the user has in common with one or more users.

Alternatively, the coordinate system is a polar coordinate system. A first user may be represented at the origin of the coordinate system and one or more users having attributes in common with the first user are displayed on the coordinate system at a distance and angle from the origin.

The attribute may be a URL, an ISBN or another unique identifier.

The attribute may be selected from a predetermined list stored on a database. The predetermined list may be a list of musical artists, films, hobbies or usage of software applications.

Preferably, the method further includes the step of selecting the representation of the one or more users on the display and displaying one or more URLs which have been accessed by the one or more selected users.

Preferably, the method further includes the step of selecting the representation of the one or more users on the display and displaying one or more URL bookmarks associated with the one or more selected users.

In a third broad form, the present invention provides a method of determining similar attributes between one or more users in a communications network including the steps of:
(a) determining one or more attributes of one or more users on a communications network;
(b) comparing the one or more attributes of the one or more users on the communications network;
(c) using an inference filter to determine the one or more attributes in common with the one or more users;
(d) representing the one or more users which have one or more attributes in common on a display;
(e) selecting one or more users on the display; and
(f) indexing one or more attributes associated with the one or more selected users and storing in a database.

Preferably, the method further includes the steps of:
(g) receiving a query from a user;
(h) accessing the database and identifying one or more indexed attributes, each attribute associated with a selected user that match the query; and
(i) returning the query to the user by displaying the attributes to the user.

Preferably, the attribute is a URL.

Preferably, the method further includes the step of paying a referral fee to the selected user upon a user clicking a URL associated with the selected user.

The present invention also provides software for use with a computer including a processor and associated memory device for storing the software, the software including a series of instructions to cause the processor to carry out a method according to the first, second and third broad forms of the invention.

### BRIEF DESCRIPTION OF THE DRAWINGS

The invention will now be described in further detail by reference to the accompanying drawings. It is to be understood that the particularity of the drawings does not supersede the generality of the preceding description of the invention.

FIG. 1 is a schematic diagram showing a system for determining similar attributes between one or more users in a communications network;

FIG. 2 is a schematic diagram showing various functional elements of the system of FIG. 1 in block form.

FIG. 3 illustrates a flow diagram of an example of a method of determining similar attributes between one or more users in a communications network according to a first embodiment;

FIG. 4a to 4d illustrates examples of the representations of the user terminals and the relationship between them.

FIG. 5 and 6 illustrate screen layouts suitable for use with an embodiment of the invention;

FIG. 7 illustrates a flow diagram of an example of a method of determining similar attributes between one or more users in a communications network according to a second embodiment;

FIGS. 8 and 9 illustrate screen layouts suitable for use with an embodiment of the invention;

FIG. 10 illustrates a flow diagram of an example of a method of determining similar attributes between one or more users in a communications network according to a third embodiment;

### DETAILED DESCRIPTION

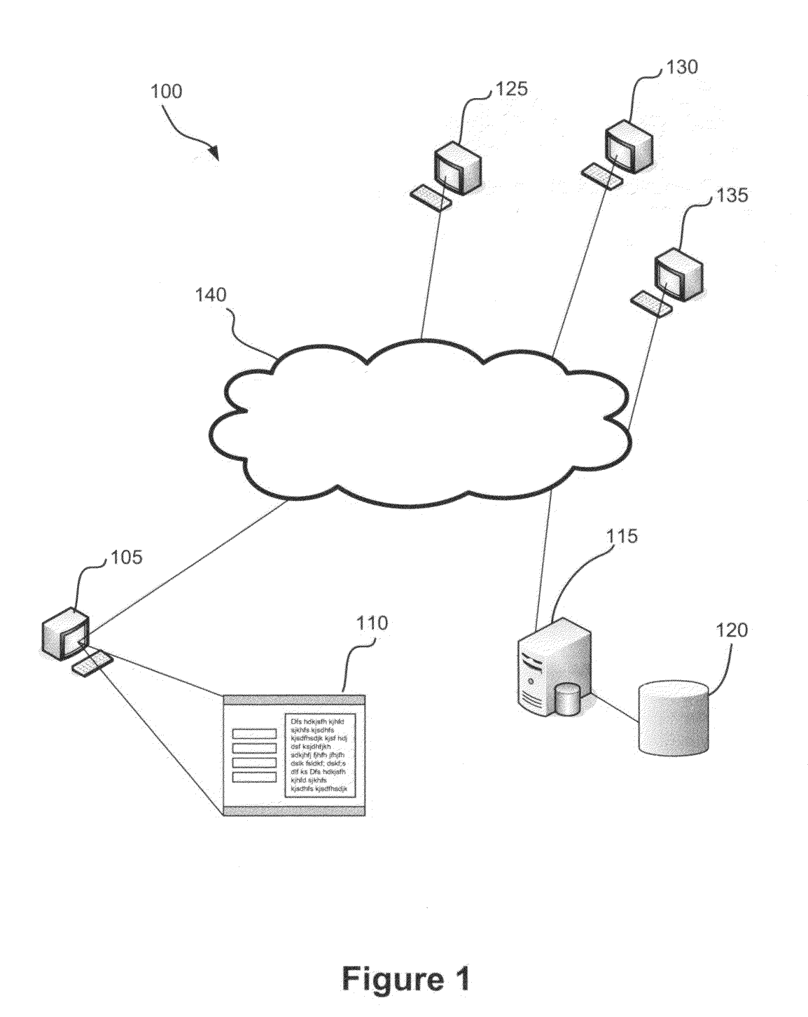

Referring to FIG. 1, there is shown an example system for determining similar attributes between one or more users in a communications network. The system 100 includes a first user terminal 105 having a graphic user interface 110, one or more additional user terminals 125, 130, 135 and a database 120 in communication with a server 115 and the first user terminal 105 and additional user terminals 125, 130, 135. The first user terminal 105 (and additional user terminals 125, 130, 135) and server 115 are interconnected by means of a network 140 such as the Internet or any other suitable communications network.

Attribute data available for use by the first user terminal 105 is maintained remotely from the first user terminal 105 in the database 120. The attribute data in the database is accessed by a user via the first user terminal 105. The user interacts with the system 100 via graphic user interface 120. Whilst in this embodiment of the invention the attribute data is maintained remotely in database 120, it will be appreciated that the attribute data may also be made accessible to the user terminal 110 in any other convenient form, such as data stored locally on the first user terminal 105 and additional. user terminals 125, 130, 135.

The system 100 may be implemented using hardware, software or a combination thereof and may be implemented in one or more computer systems or processing systems. In particular, the functionality of the first user. terminal 105 and additional user terminals 125, 130, 135 and their graphic user interface 110, as well as the server 115 may be provided by one or more computer systems capable of carrying out the above described functionality.

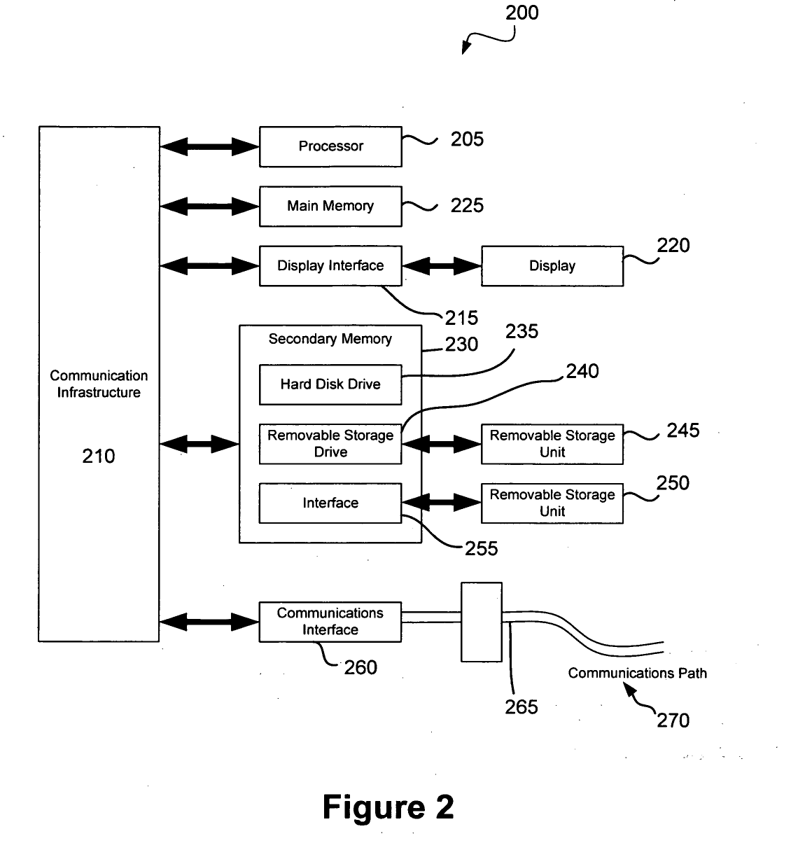

An exemplary computer system 200 is shown in FIG. 2. The computer system 200 includes one or more processors, such as processor 205. The processor 205 is connected to a communication infrastructure 210. The computer system 200 may include a display interface 215 that forwards graphics, texts and other data from the communication infrastructure 210 for supply to the display unit 220. The computer system 200 may also include a main memory 225, preferably random access memory, and may also include a secondary memory 230.

The secondary memory 230 may include, for example, a hard disk drive, magnetic tape drive, optical disk drive, etc. The removable storage drive 240 reads from and/or writes to a removable storage unit 245 in a well known manner. The removable storage unit 245 represents a floppy disk, magnetic tape, optical disk, etc.

As will be appreciated, the removable storage unit 240 includes a computer usable storage medium having stored therein computer software in a form of a series of instructions to cause the processor 205 to carry out desired functionality. In alternative embodiments, the secondary memory 230 may include other similar means ‘for allowing’ computer programs or instructions to be loaded into the computer system 200. Such means may include, for example, a removable storage unit 250 and interface 255.

The computer system 200 may also include a communications interface 260. Communications interface 260 allow software and data to be transferred between the computer system and 100 and external devices. Examples of communication interface 260 may include a modem, a network interface, a communications port, a PCMIA slot and card etc. Software and data transferred via a communications interface 260 are in the form of signals 330 which may be electromagnetic, electronic, optical or other signals capable of being received by the communications interface 260. The signals are provided to communications interface 260 via a communications path 270 such as a wire or cable, fibre optics, phone line, cellular phone link, radio frequency or other communications channels.

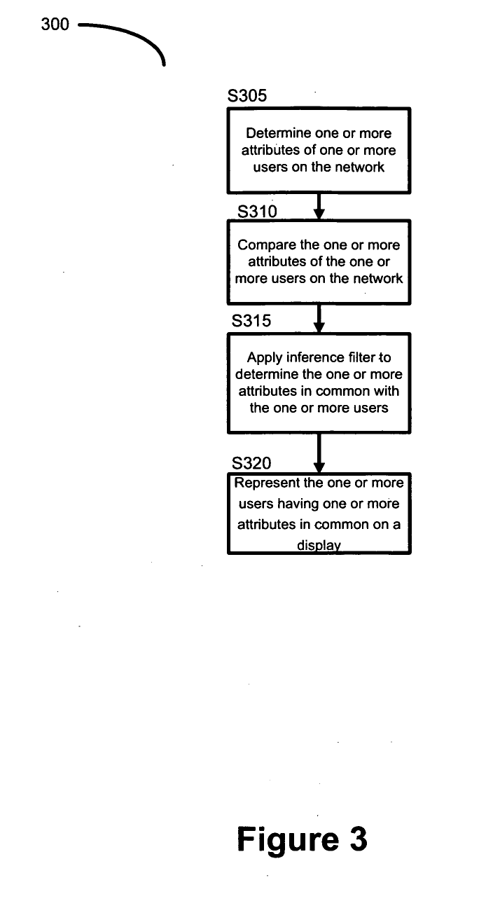

Referring to FIG. 3, there is shown an example of a method 300 of determining similar attributes between one or more users in a communications network. With reference to FIG. 1, the users of the system 100 may be first user terminal 105 and one or more additional user terminals 125, 130, 135 all connected to a network 140 such as the Internet. The present invention will be described with reference to a first user operating the first user terminal 105 using the system 100. At step 305, one or more attributes of the one or more users on the network 140 are determined. Attributes associated with the first user terminal 105 and additional user terminals 125, 130, 135 may be stored on a database 120 in communication with a server 115 which is connected to the network 140 or may be stored locally on the respective user terminal. The attributes may include Universal Resource Locators (URLs) which are associated with the user terminal. Alternatively, the attribute may be an International Standard Book Number (ISBN) associated with the user terminal. In a further alternative, the attribute may be predetermined list stored on the database 120 on the server 115 or on a local database associated with the user terminal. The predetermined list may include a list of musical artists, films, hobbies or usage of software applications that the user associated with the user terminal is interested in. Once the attributes have been determined, at step 310 the one or more attributes determined from the first user terminal 105 and additional user terminals 125, 130, 135 on the network 140, are compared against the attributes associated with the first user terminal 105. At step 315 an inference filter is applied to determine the attributes that the first user terminal 105 has in common with additional user terminals 125, 130, 135. The inference filter may be any suitable filter to determine the similarity between the first user terminal 105 and the additional user terminals 125, 130, 135. Any suitable inference filter may be used such as the k-nearest-neighbourhood method (k-NN) or a collaborative filter algorithm e.g. Popularity, Weighted majority, Extended Direct Bayesian prediction. Attributes may be in the form of one or more URLs' in common and the similarity between users may be determined using the k-nearest-neighbourhood method (k-NN) algorithm on the URLs associated with each of the terminals.

For example, in a simplified case, if the first user terminal 105 is associated with 100 URLs and the additional user terminal 125 is also associated with 100 URLs but with 20 URLs being the same URLs as those associated with the first user terminal 105, then the distance would be 80. Alternatively, if the first user terminal 105 and the additional terminal 125 visited exactly the same URLs, then the distance would be 0.

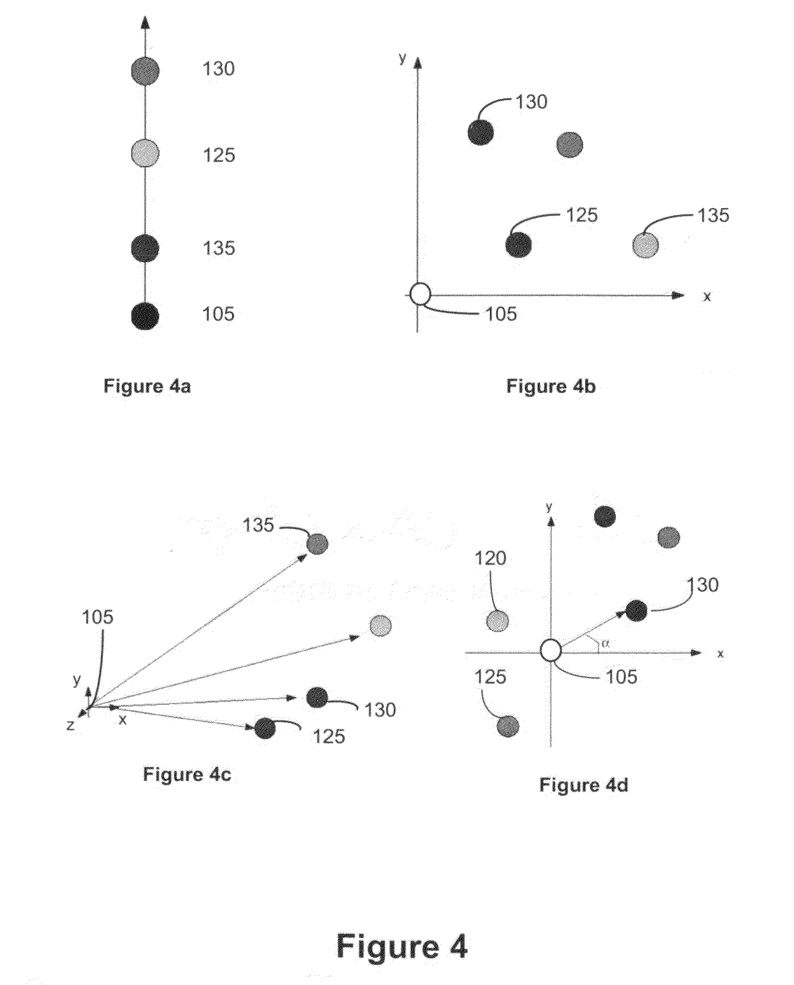

Once the one or more attributes in common between one or more users has been determined, at step 320 the attributes in common between the first user terminal and additional terminals are displayed in a format that is easy to understand. Preferably it is displayed on a graphic user interface 110 on the first user terminal 105. Preferably, the display includes a representation of the first user terminal 105 and additional user terminals 125, 130, 135 and graphically illustrates the relationship between the first user and the additional terminals (i.e. the number of attributes in common between the one or more users). Preferably the relationship between the first user and the additional terminals is displayed in a plot with the first user at the origin of the plot and the additional users at another position relative to the origin where the position indicates the similarity between users. It is also preferable that the representation of each user terminal indicates whether the user is currently on the network 140 or not. Example representations are shown in further detail in FIG. 4.

FIG. 4 illustrates examples of the representations of the user terminals and the relationship between them once the similarity has been determined. In FIG. 4a, the display is a one dimensional Cartesian coordinate system showing the first user terminal 105 at the origin of the plot and the additional user terminals 125, 130, 135 at distances away from the first user terminal 105. In this case, additional user terminal 135 has the most attributes in common with the first user terminal 105, followed by additional terminal 125 and finally additional terminal 130. Although not shown, the distance between the user terminals can be quantified. The user terminals 105, 125, 130 and 135 may be colored to indicate the status of a user terminal. For example, blue=user terminal online, red=user offline and flashing blue=user terminal online and currently visiting the same URL as the user terminal 105 at the origin.

FIG. 4b illustrates a two dimensional cartesian coordinate system showing the first user terminal 105 at the origin of the plot and the additional user terminals 125, 130, 135 at distances away from the first user terminal 105. In this case, there is scope for the similarity of users on a network to be determined with two attributes (i.e. one attribute for each axis). In this case, additional user terminal 125 has more similarity with first user terminal 105 than additional user terminal 135 in respect of an attribute denoted by the X axis, but approximately the same level of similarity with regard to a second attribute (denoted by the Y axis). Similarly, additional user 130 has more similarity with first user terminal 105 than additional terminal 125 in respect of the attribute on the x axis but not the y axis.

FIG. 4c illustrates a three dimensional Cartesian coordinate system showing the first user terminal 105 at the origin of the plot and the additional user terminals 125, 130, 135 at distances away from the first user terminal 105. In this case, there is scope for the similarity of users on a network to be determined with three attributes (i.e. one attribute for each axis).

FIG. 4d illustrates a two dimensional polar coordinate system showing the first user terminal 105 at the origin of the plot and the additional user terminals 125, 130, 135 at a distance away and an angle from the first user terminal 105. In this case, there is scope for the similarity of users on a network to be determined with two attributes (i.e. one attribute for the distance from the origin and one attribute associated with the angle).

It will be appreciated that other coordinate systems could be used in any number of dimensions depending on the number of attributes to display. Alternatively, each axis in the coordinate system could represent a combination of attributes.

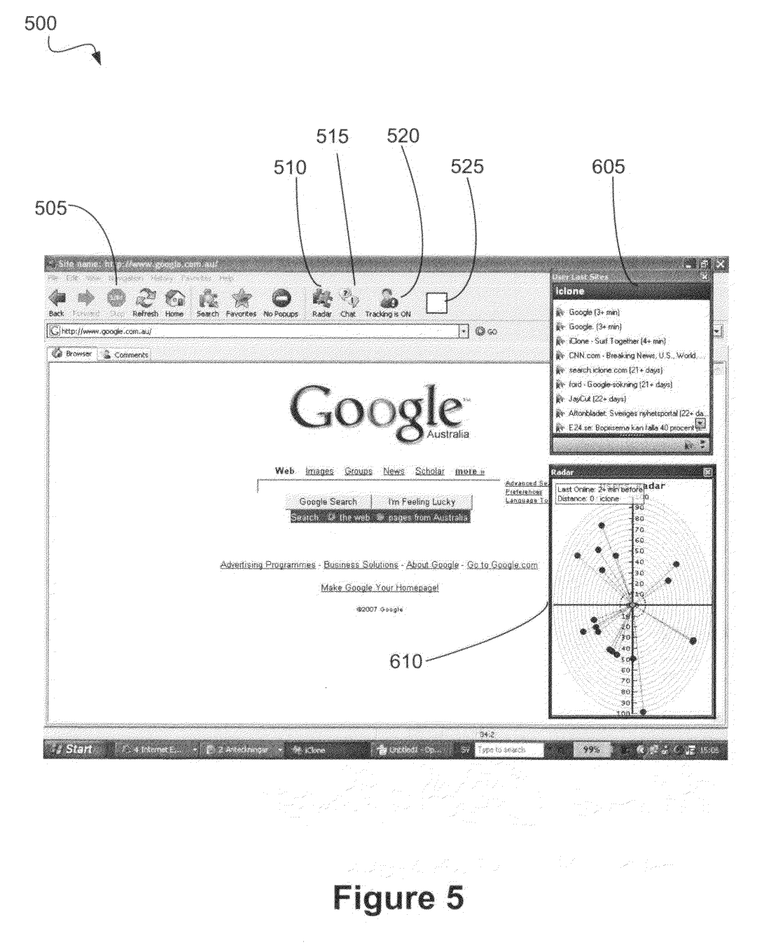

FIG. 5 illustrates a screen layout 500 showing a web browser suitable for use with a method according to the invention. The screen layout 500 may represented on a graphic user interface 110 of the first user terminal 105. The screen layout 500 includes browsing buttons 505 which are commonly associated with a web browser and further buttons including a radar button 510, a chat button 515, a URL button 520 and an “interesting site” button 525.

The method of the present invention collect attributes and determines the similarity between users from these attributes. In the case of the attribute being URLs, the present invention stores URLs that users visit in a database 120. The database 120 may be on a central server or may be stored on the user terminal 105, 125, 130, 135. The URLs may be ranked for each user such that the first ranked URL associated with a user is the URL that they visit most often.

The method of the present invention may be implemented as a plug-in for the browser or may be a standalone application that runs alongside the browser. In this case, if a user does not want to send their URLs to the database 120 on the server 115, the user can simply use load their web browser(i.e. use their normal web browser).

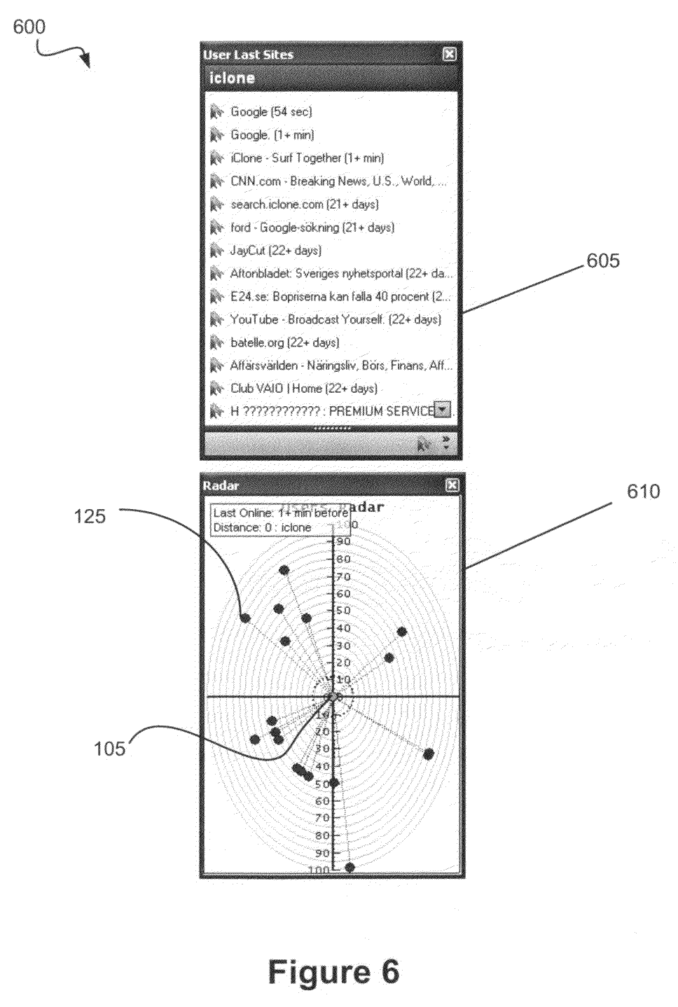

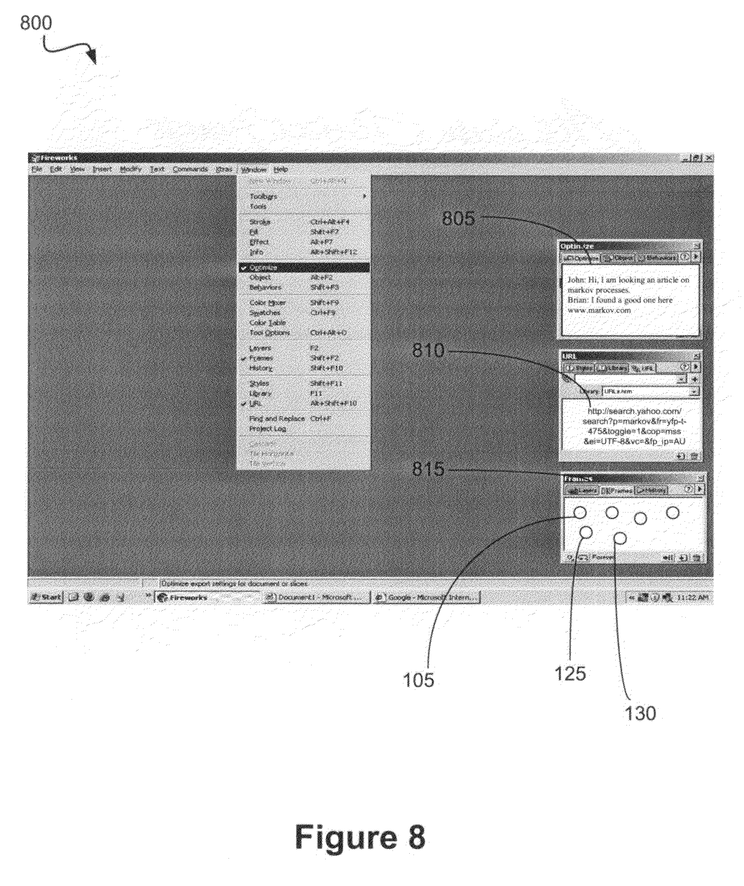

In operation, a user operating the first user terminal 105, uses the browser in a normal manner such as entering a URL into the address bar of the browser or selecting a bookmark. Pressing the radar button 510 displays a window 605, 610 showing users having attributes in common with the user of the first user terminal 105 and is further described with reference to FIG. 6. Pressing the chat button 515 displays a chat box window where one or more users can chat to each other and is further described with reference to FIG. 8. Pressing the URL button 515 displays a window where one or more users are who are viewing the same URL are shown and is further described with reference to FIG. 8. Pressing the “Interesting site”.button 525 indicates to other user terminals that a user that is currently visiting that URL considers the URL of interest.

FIG. 6 illustrates a screen layout 600 of a display which appears on the graphic user interface 110 upon pressing the radar button 510 in FIG. 5. The screen layout includes a window 605 which lists the attributes (in this case URLs) in common and a graph 610 which is a two dimensional cartesian coordinate system displaying the attributes (in this case URLs). As can be seen in FIG. 6, the first user terminal 105 is located at the origin of the graph 610 with a number of similar minded users are located on various points of the graph 610 at a distance away from the origin. As described with reference to FIG. 4, one or more attributes may be considered and may be represented on the graph 610 having a number of axes.

Any number of dimensions can be used with each axis representing one attribute. The data that is used to identify attributes can be can be implicit data (such as by monitoring behaviour such as surfing the World Wide Web) or explicitly (i.e. the user explicitly provides the data).

If, for example, the attribute of “books” has been defined as a user's interest then the attribute needs to be quantified in order to find and display similar users in the network.

The attributes can be quantified either manually, from a URL or from a third party: Manually quantifying attributes, involves a user entering the attribute (e.g. books) that are favourites. A book may be identified by its ISBN number.

Quantifying attributes from a URL involves the system parsing URL history of a user. In the case of “books” as an attribute, URLs that contains a book merchant such as www.amazon.com can be examined and parsed for an identifier such as an ISBN. Typically, when a user clicks on a book, the ISBN can be seen in the URL. Alternatively, when the user clicks on “Buy” at the checkout point, the ISBN from that URL can be extracted. The ISBNs can then be stored on a database 120. The number of matching ISBNs between of one or more users may then be plotted along an axis.

Preferably, a user's book profile is built up from their purchases, or alternatively the user may inspect the purchases and mark the books they found interesting.

Another way of quantifying attributes is by a third party using the method of the present invention. An example of a third party may be amazon.com.

As an example, a 4 dimensional display of attributes (movies, books, music and URLs) which is created from a user's URL stream would occur as follows:

If the user has visited the website amazon.com or another-book merchant, the ISBN or Amazon Standard Identification Number (ASIN) can be extracted from the URL. A user's URL stream can be divided into different attributes (e.g movies, books, music) by extracting the URLs that contain amazon.com. The ISBN can then be stored on the database 120.

URLs containing references to music, e.g. itunes.com can be extracted and the music identification number of songs and be stored on the database 120. The URLs containing purchases of movies are stored on the database 120 and the rest of the URLs are then stored on the database 120. The display may then be made of four axes or one or more attributes could be combined (e.g. movies and books) to reduce the number of axes, depending on settings.

Assuming none of the attributes are combined, the attributes will be defined by 4 dimensions w, x, y, z representing movies, books, music and other URLs respectively.

The URL stream of a user is inspected and all URLs containing amazon.com, itunes.com, etc being purchased are quantified. In the case of the first user terminal 105 purchasing 10 books from amazon.com, 20 songs from iTunes.com, and 15 movies from amazon.com and 100 other URLs, the attributes of the first user terminal 105 may be represented as (10, 20, 15, 100).

Then another user terminal 125 has its URL stream inspected and it is determined that user terminal 125 has purchased 5 of the same books, 20 of the same songs, 10 of the same movies and visited 90 of the same URLs. The attributes of the user terminal 125 may be represented as (5, 20, 10, 90). Therefore, when displaying the similarity between the users, the distance between the first user terminal 105 and the user terminal 125 will be 5 on the w axis, 0 on the x axis, 5 on the Y axis and 10 on the Z axis.

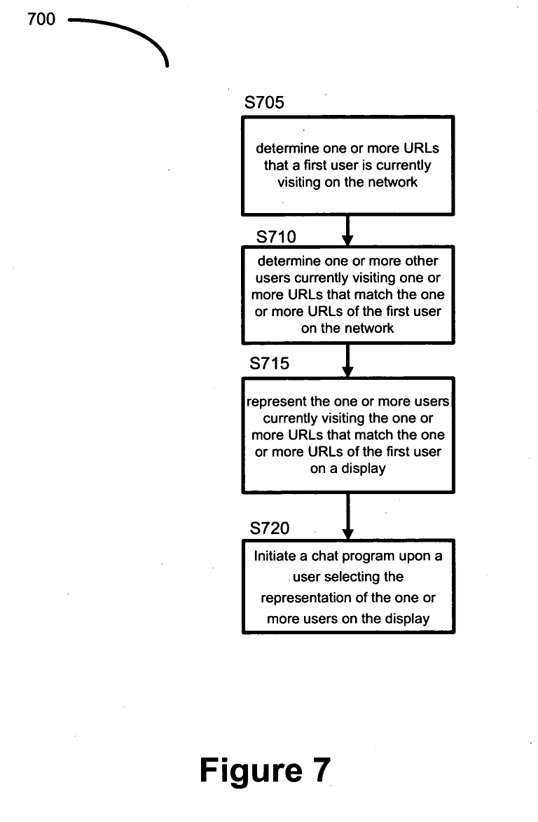

Referring to FIG. 7, a second embodiment of an example of a method 700 of determining similar attributes between one or more users in a communications network. With reference to FIG. 1, the users of the system 100 may be first user terminal 105 and one or more additional user terminals 125, 130, 135 all connected to a network 140 such as the Internet. The present invention will be described with reference to a first user operating the first user terminal 105 using the system 100. At step 705, one or more URLs that the first user terminal 105 is currently visiting on the network 140 are determined. URLs associated with the first user terminal 105 may be stored on a database 120 in communication with a server 115 which is connected to the network 140 or may be stored locally on the user terminal.

Once the URLs associated with the first user terminal 105 have been determined, at step 710 one or more other users currently visiting one or more URLs that match the one or more URLs in step 705 on the network 140 are determined. At step 715, the one or more users currently visiting the one or more URLs that match the one or more URLs in step 710 are represented on a display. Preferably, the one ore more users currently visiting the same URL as the user of the first user terminal 105 are displayed in a format that is easy to understand. Preferably it is displayed on a graphic user interface 110 on the first user terminal 105. Preferably, the display includes a representation of the first user terminal 105 and additional user terminals 125, 130, 135 and graphically illustrates whether the user is currently online or available for chat. In addition, the display may further include the relationship between the first user and the additional terminals (i.e. the number of attributes in common between the one or more users) and a representation of the first user terminal 105 and additional user terminals 125, 130, 135 and graphically illustrates the relationship between the first user and the additional terminals (i.e. the number of attributes in common between the one or more users).

At step 720, a chat program is initiated upon the first user terminal 105 selecting one more user terminals which at step 715 have been determined as visiting the same URL. The first user terminal 105 may select the one or more user terminals by selecting a graphical representation of the user. Preferably, the graphical representation of the user indicates whether the user is currently on the network 140 or not. The graphical representation may be the same as that described in FIG. 4. Following step 720, the method may further include the steps described in FIG. 3, namely determining one or more attributes of one or more users currently visiting one or more URLs in step 705, comparing the one or more attributes of the one or more users currently visiting one or more URLs in step 705, using an inference filter as described in FIG. 3 to determine the one or more attributes in common with the one or more users, and representing the one or more users which have one or more attributes in common on a display. The display may be as described with reference to FIG. 4. including a coordinate system indicating the number of attributes in common between the one or more users. In this case, the attributes between users who are visiting the same URL may be a URL (how many URLs users have in common, either visited or bookmarked), an ISBN or an attribute selected from a predetermined list stored on a database (the predetermined list may be a list of musical artists, films, hobbies or usage of software applications).

In the case of the an attribute of interest being a users usage of software applications (e.g. if the user frequently uses Microsoft™ Word or Microsoft™ Excel), then one axis (e.g. an x-axis in a two dimensional coordinate system) may represent the similarly between heavy users of Microsoft™ Word while another axis (e.g. the y axis in a two dimensional coordinate system) may represent the similarity in URLs visited between users. In this way, the first user terminal 105 who is an author with an interest in science fiction could see other users who like to write and visit science fictions sites. Further, the first user terminal 105 may also select the representation of the one or more users on the display and display and invite them to share a collaborative Microsoft™ Word document such as Google™ Docs and co-author a science fiction story. In a further alternative, the user associated with the first user terminal 105 may be a scientist working on a spreadsheet and selects other scientists to invite them to work together.

In an alternative, the first user terminal 105 may also select the representation of the one or more users on the display and display one or more URLs which have been accessed by the one or more selected users. In a further alternative, the user may select the representation of the one or more users on the display and display one or more URL bookmarks associated with the one or more selected users. Advantageously, this allows a user to visit the websites that a like minded user visits.

FIG. 8 illustrates a screen layout 800 for use with a method according to a second embodiment of the invention. The screen layout is a display which appears on the graphic user interface 110 upon pressing the chat button 515 and the URL button 520 in FIG. 5. The screen layout 800 includes a chat window 805, a URL window 810 and a user window 815. The URL window displays the current URL that the first user terminal 105 is browsing. As shown, the first user terminal 105 is browsing the URL: “http://search.yahoo.com/search?p=markov&fr=yfp-t-475&toggle=1&cop=mss &ei=UTF-8&vc=&fp_ip=AU” (i.e. the Yahoo URL with a search query of Markov) The user window 815 displays the users that are currently browsing the URL in the URL window 810 (i.e. “http://search.yahoo.com/search?p=markov&fr=yfp-t-475&toggle=1&cop=mss &ei=UTF-8&vc=&fp_ip=AU”). For example, user terminals 125 and 130 (amongst other users) are currently browsing “http://search.yahoo.com/search?p=markov&fr=yfp-t-475&toggle=1&cop=mss &ei=UTF-8&vc=&fp_ip=AU”. Each of the users in the user window 815 is graphically represented in such a way that it is clear whether the user is currently online or available for chat or both. Whether a user is online or not may be represented by a colour (e.g. green for online, red for offline). Whether a user is available for chat may also be represented by a colour or by a graphic effect such as flashing.

In operation, a first user terminal 105 (John) is currently visiting the URL “http://search.yahoo.com/search?p=markov&fr=yfp-t-475&toggle=1&cop=mss &ei=UTF-8&vc=&fp_ip=AU” and is looking for an article on Markov processes. Another user terminal 125 (Brian) is also visiting the URL “http://search.yahoo.com/search?p=markov&fr=yfp-t-475&toggle=1&cop=mss &ei=UTF-8&vc=&fp_ip=AU”. In this case, first user terminal 105 (John) notes that another user terminal 125 (Brian) is also online and available for chat by looking at the user window 815. By clicking on the representation of the user terminal 125 in the user window 815 the first user terminal 105 (John opens up a chat window 805 with the other user terminal 125 (Brian)). Because they are both on the same website arid searching for Markov processes, John and Brian have a conversation about where to find a good article on Markov processes. The first user terminal 105 (John) could then visit www.markov.com and the user window 815 will be updated with users visiting www.markov.com. The first user terminal 105 (john) can then attempt to chat with other users on that site who may have more information about Markov processes.

In an alternative, when the present invention is implemented on a data communications network with mobile communications devices acting as user terminals, by selecting on the representation of the user terminal 125 in the user window 815 a map may be generated via a GPS system enabled on the mobile communications device to allow users to determine each others geographic position. The geographic position may be determined with GPS or alternatively determined by the current base stations to which the mobile communication device is connected. In a further alternative, the geographic position is determined with Radio-frequency identification (RFID) if the mobile device is equipped with a RFID tag (RFID is an automatic identification method, that relies on storing and remotely retrieving data using devices called RFID tags or transponders). In a yet another alternative, a photo of a user may be used to assist another user to identify another like minded user on the street, for example. In yet a further alternative, the user terminal in the form of a mobile communications device may produce a sound alert indicating other like minded users are in the vicinity. In this case, when an alarm sounds, a user may look at the mobile communications device and a radar representation such as that shown in FIG. 6. The user can then determine how far away other like minded users are by viewing a map associated with the location of the other user. Communication can then occur provided both parties have set their mobile communication devices to allow communication in this way.

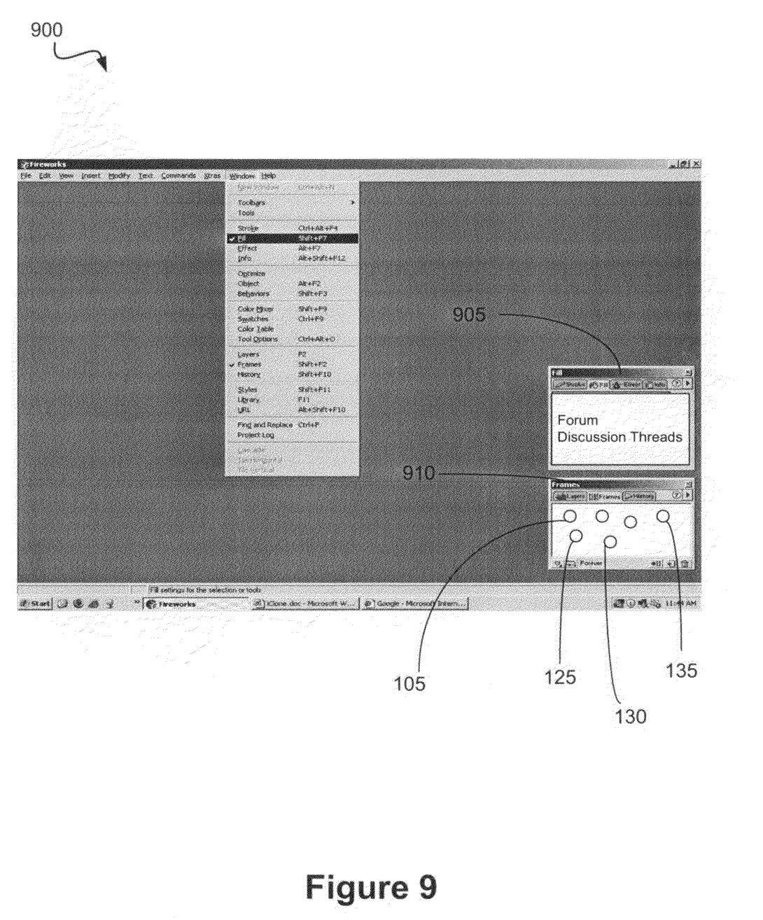

In a further alternative, as shown in FIG. 9 a discussion forum window 905 may be used with a user window 910. In operation, a first user terminal 105 is currently visiting a URL and a number of other user terminals 125, 130, 135 are also visiting the URL as shown in the user window 910. The first user terminal 105 then has an option of visiting a discussion forum 905 which is associated with the URL. The discussion board may be an official discussion board associated with the URL or may be generated dynamically.

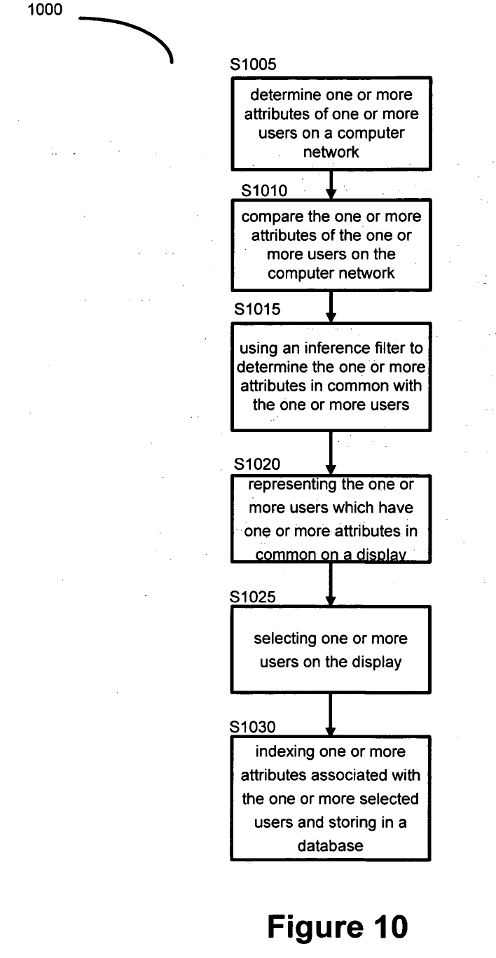

Referring to FIG. 10, there is shown an example of a method 300 of determining similar attributes between one or more users in a communications network for use in a search engine. With reference to FIG. 1, the users of the system 100 may be first user terminal 105 and one or more additional user terminals 125, 130, 135 all connected to a network 140 such as the Internet. The present invention will be described with reference to a first user operating the first user terminal 105 using the system 100. At step 1005, one or more attributes of the one or more users on the network 140 are determined. Attributes associated with the first user terminal 105 and additional user terminals 125, 130, 135 may be stored on a database 120 in communication with a server 115 which is connected to the network 140 or maybe stored locally on the respective user terminal. The attributes may include Universal Resource Locators (URLs) which are associated with the user terminal. Alternatively, the attribute may be an International Standard Book Number (ISBN) associated with the user terminal. In a further alternative, the attribute may be predetermined list stored on the database 120 on the server 115 or on a local database associated with the user terminal. The predetermined list may include a list of musical artists, films, hobbies or usage of software applications that the user associated with the user terminal is interested in. Once the attributes have been determined, at step 1010 the one or more attributes determined from the first user terminal 105 and additional user terminals 125, 130, 135 on the network 140, the attributes are compared against the attributes associated with the first user terminal 105. At step 1015 an inference filter is applied to determine the attributes that the first user terminal 105 has in common with additional user terminals 125, 130, 135. The inference filter may be any suitable filter to determine the similarity between the first user terminal and the additional user terminals 125, 130, 135. Any suitable inference filter may be used such as the k-nearest-neighbourhood method (k-NN) or a collaborative filter algorithm e.g. Popularity, Weighted majority, Extended Direct Bayesian prediction. In the case attributes in the form of one or more URLs in common the similarity between users may be determined using the k-nearest-neighbourhood method (k-NN) algorithm on the URLs associated with each of the terminals.

Once the one or more attributes in common between one or more users has been determined, at step 1020 the attributes in common between the first terminal and additional terminals are displayed in a format that is easy to understand. Preferably it is displayed on a graphic user interface 110 on the first user terminal 105. Preferably, the display includes a representation of the first user terminal 105 and additional user terminals 125, 130, 135 and graphically illustrates the relationship between the first user and the additional terminals (i.e. the number of attributes in common between the one or more users). Preferably the relationship between the first user and the additional terminals is displayed in a plot with the first user at the origin of the plot and the additional users at another position relative to the origin where the position indicates the similarity between users. It is also preferable that the representation of each user terminal indicates whether the user is currently on the network 140 or not. Example representations are shown in further detail in FIG. 4. At step 1025 a user may select one or more users which have one or more attributes in common from the display. This may be by selecting the one or more users via an input device such as a mouse. Attributes associated with the one or more selected users are then indexed to a database 120 which is in communication with a server 115.

In operation, once the attributes of one or more users have been indexed to the database 120, the first user terminal 105 can enter a query via the graphic user interface 110. The database 120 is accessed and queried where it identifies one or more attributes and returns these results to the first user terminal 105 where the results are displayed on a graphic user interface 110.

For example, if a first user terminal selects a number of other user terminals from representation of the user terminals and the relationship between them (such as described in FIG. 4), then the attributes associated with these user terminals are indexed on the database 120. The first user terminal 105 may enter “good movie” as a search query. The database is queried for movies and this is returned to the first user terminal 105. Advantageously, a search for “good movies” will return better search results compared with the irrelevant results of searching for “good movies” on a traditional search engine.

Each of the attributes indexed and on the database 120 may be associated with a user terminal. Therefore, when the first user terminal 105 receives the results of the query in the form of attributes (such as URL for a book title, URL for a song to purchase) any URL that is visited on by the first user terminal 105 which results in a sale, a referral fee may be paid to the user associated with the user terminal that provided the link to the first user terminal 105.

For example, if a first user terminal 105 searches for “good movies” and a number of results are returned for “good movies” which include URLs to purchase the movie, then if the movie is purchased via that URL, a referral fee may be paid. The referral fee can be paid to the user terminal that the result was retrieved from.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

The invention can be further described by the following points:

1. A method of determining similar attributes between one or more users in a network communications including the steps of:
(a) determining one or more attributes of one or more users on a communications network;
(b) comparing the one or more attributes of the one or more users on the communications network;
(c) using an inference filter to determine the one or more attributes in common with the one or more users; and
(d) representing the one or more users which have one or more attributes in common on a display.

2. The method of claim 1, wherein the display is a coordinate system indicating the number of attributes in common between the one or more users.

3. The method of claim 1, wherein the display is a coordinate system having one or more axes, each axis representing an attribute.

4. The method of claim 1, wherein the display is a coordinate system having one or more axes, each axis representing a combination of one or more attributes.

5. The method of any one of claims 2 to 4, wherein a first user is represented at the origin of the coordinate system and one or more users having attributes in common with the first user are displayed on the coordinate system at a distance from the origin.

6. The method of any one of claims 2 to 4, wherein the coordinate system is a Cartesian coordinate system.

7. The method of claim 5, wherein the distance from the first user at the origin is the number of attributes that the user has in common with one or more users.

8. The method of any one of claims 2 to 4 wherein the coordinate system is a polar coordinate system.

9. The method of claim 8, wherein a first user is represented at the origin of the coordinate system and one or more users having attributes in common with the first user are displayed on the coordinate system at a distance and angle from the origin.

10. The method of claim 1, wherein attribute is a URL.

11. The method of claim 1 or 10, wherein attribute is an ISBN or another unique identifier.

12. The method of claim 1, wherein attribute is selected from a predetermined list stored on a database.

13. The method of claim 12, wherein the predetermined list is a list of musical artists, films, hobbies or usage of software applications.

14. The method of claim 1, wherein the representation of the one or more users on the display indicates if the one or more users are on the communications network.

15. The method of claim 1, further including the step of initiating a chat program upon selecting a representation of the one or more users on the display.

16. The method of claim 1, further including the step of selecting a representation of the one or more users on the display and displaying one or more URLs which have been accessed by the one or more selected users.

17. The method of claim 1, further including the step of selecting the representation of the one or more users on the display and displaying one or more URL bookmarks associated with the one or more selected users.

18. A method of determining similar attributes between one or more users in a communications network including the steps of:
(a) determining one or more URLs that a first user is currently visiting on the network;
(b) determining one or more other users currently visiting one or more URLs that match the one or more URLs in step (a) on the network;
(c) representing the one or more users currently visiting the one or more URLs that match the one or more URLs in step (a) on a display; and
(d) initiating a chat program upon a user selecting the representation of the one or more users on the display.

19. The method of claim 18, wherein the display is a list of users currently visiting one or more URLs that match the one or more URLs in step (a).

20. The method of claim 18 or 19, wherein the display indicates if the one or more users are available to chat.

21. The method of claim 18, further including the steps of
(e) determining one or more attributes of one or more users currently visiting one or more URLs in step (a);
(f) comparing the one or more attributes of the one or more users currently visiting one or more URLs in step (a);
(g) using an inference filter to determine the one or more attributes in common with the one or more users; and
(h) representing the one or more users which have one or more attributes in common on a display.

22. The method of claim 21, wherein the display is a coordinate system indicating the number of attributes in common between the one or more users.

23. The method of claim 21, wherein the display is a coordinate system having one or more axes, each axis representing an attribute.

24. The method of claim 21, wherein the display is a coordinate system having one or more axes, each axis representing a combination of one or more attributes.

25. The method of any one of claims 22 to 24, wherein a first user is represented at the origin of the coordinate system and one or more users having attributes in common with the first user are displayed on the coordinate system at a distance from the origin.

26. The method of any one of claims 22 to 24, wherein the coordinate system is a Cartesian coordinate system.

27. The method of claim 25, wherein the distance from the first user at the origin is the number of attributes that the user has in common with one or more users.

28. The method of any one of claims 22 to 24 wherein the coordinate system is a polar coordinate system.

29. The method of claim 28, wherein a first user is represented at the origin of the coordinate system and one or more users having attributes in common with the first user are displayed on the coordinate system at a distance and angle from the origin.

30. The method of claim 21, wherein attribute is a URL.

31. The method of claim 21 or 30, wherein attribute is an ISBN.

32. The method of claim 21, wherein attribute is selected from a predetermined list stored on a database.

33. The method of claim 32, wherein the predetermined list is a list of musical artists, films, hobbies or usage of software applications.

34. The method of claim 18, further including the step of selecting the representation of the one or more users on the display and displaying one or more URLs which have been accessed by the one or more selected users.

35. The method of claim 18, further including the step of selecting the representation of the one or more users on the display and displaying one or more URL bookmarks associated with the one or more selected users.

36. A method of determining similar attributes between one or more users in a communications network including the steps of:
(a) determining one or more attributes of one or more users on a communications network;
(b) comparing the one or more attributes of the one or more users on the communications network;
(c) using an inference filter to determine the one or more attributes in common with the one or more users;
(d) representing the one or more users which have one or more attributes in common on a display;
(e) selecting one or more users on the display; and
(f) indexing one or more attributes associated with the one or more selected users and storing in a database.

37. The method of claim 36, further including the steps of:
(g) receiving a query from a user;
(h) accessing the database and identifying one or more indexed attributes, each attribute associated with a selected user that match the query; and
(i) returning the query to the user by displaying the attributes to the user.

38. The method of claim 36, wherein the attribute is a URL.

39. The method of claim 38, wherein the method further includes paying a referral fee to the selected user upon a user clicking a URL associated with the selected user.

40. Software for use with a computer including a processor and associated memory device for storing the software, the software including a series of instructions to cause the processor to carry out a method according to any one of claims 1, 18 or 36.
